(19) United States
(12) Patent Application Publication
(10) Pub. No.: US 2017/0188569 A1
(43) Pub. Date: Jul. 6, 2017

(54) SUPPORT MEMBER AND SUPPORT SYSTEM FOR SAFELY AND SECURELY SUPPORTING A LADDER

(71) Applicants: Howard L. Habberstad, JR., St. James, NY (US); Michael D. Beatty, Xenia, OH (US)

(72) Inventors: Howard L. Habberstad, JR., St. James, NY (US); Michael D. Beatty, Xenia, OH (US)

(21) Appl. No.: 15/397,073

(22) Filed: Jan. 3, 2017

Related U.S. Application Data
(60) Provisional application No. 62/273,555, filed on Dec. 31, 2015.

(51) Int. Cl. A01M 31/02; F16M 11/26; E06C 7/18; F16M 13/02

(52) U.S. Cl. CPC A01M 31/02; F16M 13/02; F16M 11/26; E06C 7/188

(57) ABSTRACT

A support member and support system for securing a ladder to a structure. The support member includes a U-shaped frame, a shaft assembly, and a connector. The U-shaped frame includes first and second arms interconnected by a crossbar and configured to releasably engage opposing sides of a ladder. The shaft assembly extends from the crossbar and has the connector disposed at a free end thereof. The connector is configured to releasably engage a mounting member secured to a structure. The support system includes the support member and at least one mounting member configured for use therewith.

### CROSS-REFERENCE TO RELATED APPLICATIONS

This application claims the benefit of U.S. Provisional Patent Application No. 62/273,555, filed on Dec. 31, 2015, the entire contents of which are hereby incorporated herein by reference.

### BACKGROUND

Technical Field

The present disclosure is directed to safely and securely supporting ladders. More particularly, the present disclosure is directed to a support member and support system for safely and securely supporting a ladder against a tree or other structure.

Background of the Disclosure

Ladders are used for various purposes to enable a user to ascend off-the-ground to otherwise inaccessible locations. For example, ladders are used in connection with tree stands for viewing from an off-the-ground vantage point. Hunters and other outdoorsmen utilize tree stands secured at elevated positions to trees or other structures to observe the surrounding area from an off-the-ground vantage point, e.g., to hunt, survey an area, and/or observe wildlife movement. Tree stands typically include ladders associated therewith for providing access to the elevated tree stands.

Removable ladders are often unsecured or inadequately secured, thus presenting a danger to the user. Injuries such as broken bones or even death may occur as a result of ladder falls, which are typically caused by the instability of the ladder. Removable ladders for tree stands suffer from similar issues; while permanent ladder tree stands, although capable of being secured, suffer from other drawbacks. More specifically, the use of permanent ladder tree stands requires the installation of multiple ladder tree stands in order to provide multiple different observation points and may increase the need for the periodic, e.g., seasonal, replacement as a result of exposure to natural elements, e.g., wind, rain, or local wildlife. Additionally, permanent installation of ladder tree stands may increase the chances of visual exposure, which is contrary to the typical desire to keep the ladder tree stands discrete, e.g., to avoid alerting passing wildlife and/or to keep a desirable hunting location a secret from others.

Accordingly, it would be desirable to provide a support member and support system for a ladder that is configured to safely and securely attach the ladder to a support, while remaining versatile and easily installed and removed from different locations without compromising the safety and/or stability of the ladder.

### SUMMARY

Provided in accordance with aspects of the present disclosure is a support member for a ladder including a U-shaped frame, a shaft assembly, and a connector. The U-shaped frame includes first and second arms interconnected by a crossbar. The first and second arms each define a free end configured and dimensioned to releasably engage an opposing side of a ladder. The shaft assembly extends from the crossbar of the U-shaped frame in an opposite direction as compared to the first and second arms. The connector is disposed at a free end of the shaft assembly and is configured and dimensioned to releasably engage a mounting member secured to a tree to thereby engage the free end of the shaft assembly to the tree.

In an aspect of the present disclosure, the shaft assembly includes an inner shaft and an outer shaft telescopically slidably relative to one another. In such aspects, one of the inner shaft and the outer shaft is engaged to the crossbar and the other of the inner shaft and the outer shaft has the connector disposed thereon.

In another aspect of the present disclosure, at least one engagement pin is provided for releasably engaging the inner and outer shafts to fix the inner and outer shafts relative to one another.

In still another aspect of the present disclosure, the connector includes a retainer and a first engagement member releasably engagable with the retainer. The first engagement member is configured to releasably engage a first mounting member secured to a tree or other structure to thereby engage the free end of the shaft assembly to the tree or other structure.

In yet another aspect of the present disclosure, the connector further includes a second engagement member releasably engagable with the retainer. The second engagement member is configured to releasably engage a second mounting member different from the first mounting member and secured to a tree to thereby engage the free end of the shaft assembly to the tree or other structure.

In still yet another aspect of the present disclosure, a locking pin to releasably lock the first and/or second engagement members with the retainer is provided.

Also provided in accordance with aspects of the present disclosure is a support system for a ladder. The support system includes a support member according to any of the aspects detailed herein, and a first mounting member configured and dimensioned to be secured to a tree or other structure. The connector of the support member is configured to releasably engage the first mounting member to thereby engage the free end of the shaft assembly to the tree or other structure.

In an aspect of the present disclosure, the connector of the support member includes a retainer and a first engagement member releasably engagable with the retainer. The first engagement member is configured to releasably engage the first mounting member.

In another aspect of the present disclosure, the system further includes a second mounting member configured and dimensioned to be secured to a tree or other structure. In such aspects, the connector of the support member may further include a second engagement member releasably engagable with the retainer and configured and dimensioned to releasably engage the second mounting member.

### BRIEF DESCRIPTION OF THE DRAWINGS

Various aspects and features of the present disclosure are detailed herein with reference to the drawings wherein:

FIG. 1 is a top view of a support member provided in accordance with the present disclosure;

FIG. 2 is a top view of an engagement member and locking pin provided in accordance with the present disclosure and configured for releasably engaging the engagement member with a connector of the support member of FIG. 1;

FIG. 3 is a perspective view of the support member of FIG. 1 including the engagement member of FIG. 2 engaging the support member to a mounting member;

FIG. 4 is a perspective view of the support member of FIG. 1, engagement member of FIG. 2, and mounting member of FIG. 3 in use securing a ladder tree stand to a tree;

FIG. 5A is a perspective view of an alternative mounting member provided in accordance with the present disclosure and configured for use with the support member of FIG. 1;

FIG. 5B is a side view of the mounting member of FIG. 5A engaged with a tree; and

FIG. 6 is an exploded, perspective view illustrating engagement of the mounting member of FIG. 5A with an engagement member of the support member of FIG. 1.

### DETAILED DESCRIPTION

Particular aspects and features of the present disclosure are described hereinbelow with reference to the accompanying drawings. In the following description, well-known functions or constructions are not described in detail to avoid obscuring the present disclosure in unnecessary detail.

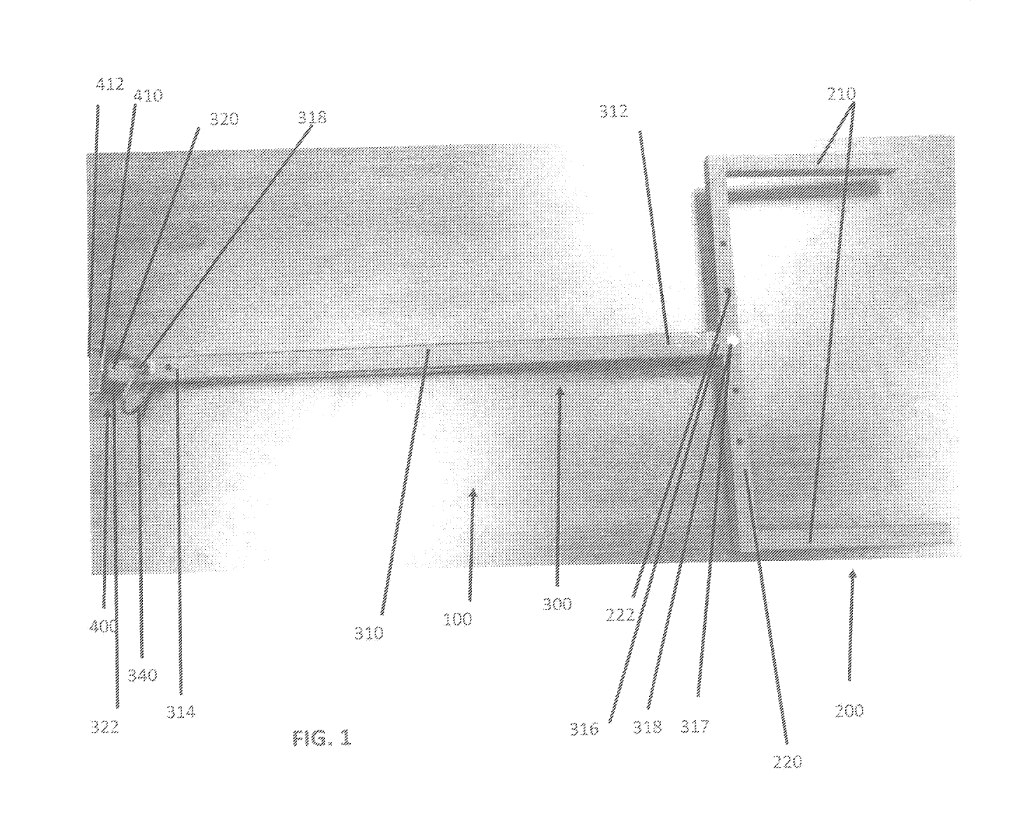

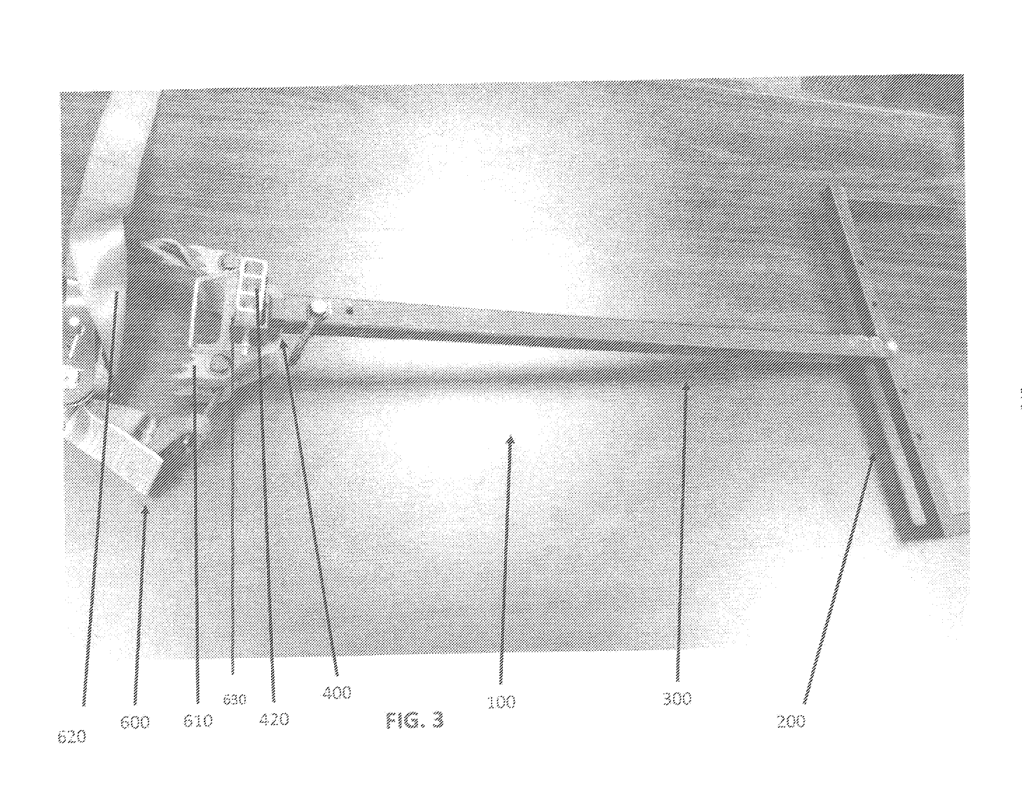

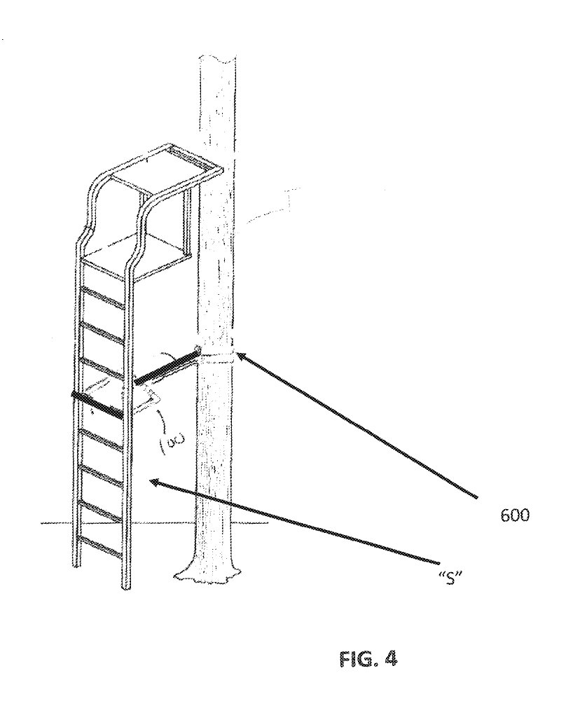

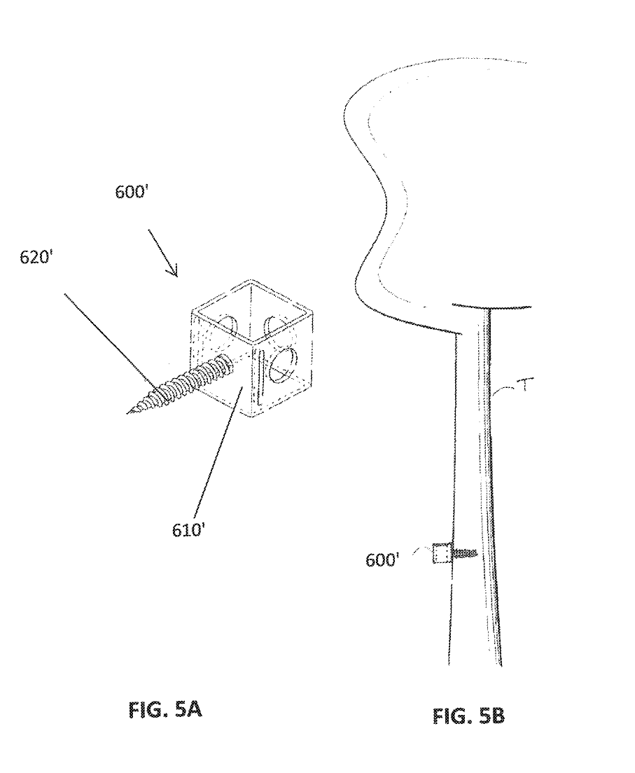

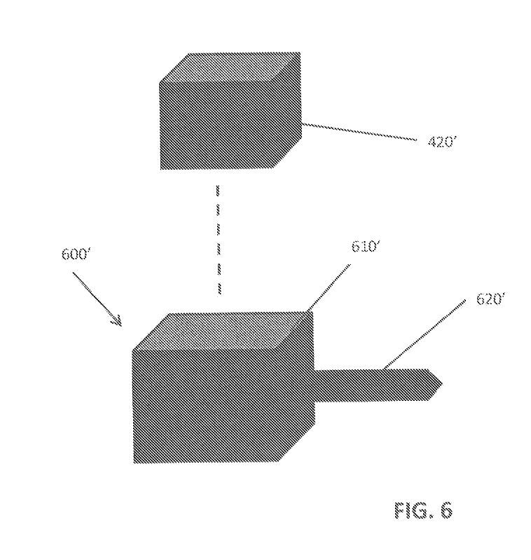

With reference to FIG. 1, a support member provided in accordance with the present disclosure is shown generally identified by reference numeral 100. Support member 100, as detailed below, is configured and dimensioned to removably attach to a mounting member 600 (FIG. 3) for securing support member 100 to a vertically orientated support structure, such as a tree “T” (FIG. 4). It will be understood that support member 100 may be attached to any suitable mounting member 600 (FIG. 3), 600′ (FIGS. 5A-5B), or a plurality of different mounting members, such as for example, 600 (FIGS. 3), and 600′ (FIGS. 5A-6) for securing support member 100 to tree “T” (FIG. 4). It will be further understood that any or all of the components of the support member 100 may be formed of suitable materials, e.g., metals or composites. In some embodiments, it is desirable to minimize the total weight of the support member 100 for ease of carrying and mounting. Accordingly, support member 100 may be partially or entirely formed of a lightweight material, e.g., a carbon fiber composite or lightweight alloy.

Referring to FIGS. 1-4, as detailed below, support member 100 includes a U-shaped frame 200; a shaft assembly 300 having an outer shaft 310 and an inner shaft 320; and a connector 400. Support member 100, as also detailed below, is configured and dimensioned for use as part of a system in conjunction with a mounting member 600 to engage support member 100 to a tree “T”.

U-shaped frame 200 includes a pair of spaced-apart arms 210 interconnected by a crossbar 220. Arms 210 define free ends configured to releasably attach to the side rails of a ladder. Such releasable attachment may be made by way of a male-female engagement, nut and bolt engagement, lock-pin engagement, latching engagement, complementary fitting, or other suitable configuration to releasably attach arms 210 of U-shaped frame 200 to a ladder, for example a ladder of a tree stand “S”. Crossbar 220 defines a plurality of apertures 222 defined therethrough and arranged in a spaced-apart fashion along crossbar 220.

Shaft assembly 300 includes an outer shaft 310 and an inner shaft 320 that are telescopically slidably relative to one another along a longitudinal axis of shaft assembly 300. Outer shaft 310, more specifically, defines a fixed end 312, a free end 314, and an inner lumen (not shown) extending longitudinally therethrough that slidably receives inner shaft 320. Fixed end 312 of outer shaft 310 includes a bracket 316 configured to engage outer shaft 310 with crossbar 220 at any one of a plurality of positions, e.g., via engagement of a bolt 317 with bracket 316 and any one of apertures 222 of crossbar 220. Outer shaft 310 further defines an aperture 318 therethrough towards the free end 314 thereof.

Inner shaft 320 includes a first end (not shown) slidably received within the inner lumen (not shown) of outer shaft 310 and a second free end 322 extending from outer shaft 310. Second end 322 of inner shaft 320 includes a connector 400, e.g., a bracket or other suitable connector, engaged thereto. Inner shaft 320 further includes a plurality of apertures (not shown) defined therethrough and arranged in a longitudinally-spaced relation along the longitudinal axis. Outer and inner shafts 310, 320 are configured to slide relative to one another to align aperture 318 of outer shaft 310 with one of the apertures (not shown) of inner shaft 320 for receipt of an engagement pin 340 therethrough to engage outer and inner shafts 310, 320, respectively, to one another at any one of a plurality of incremental positions.

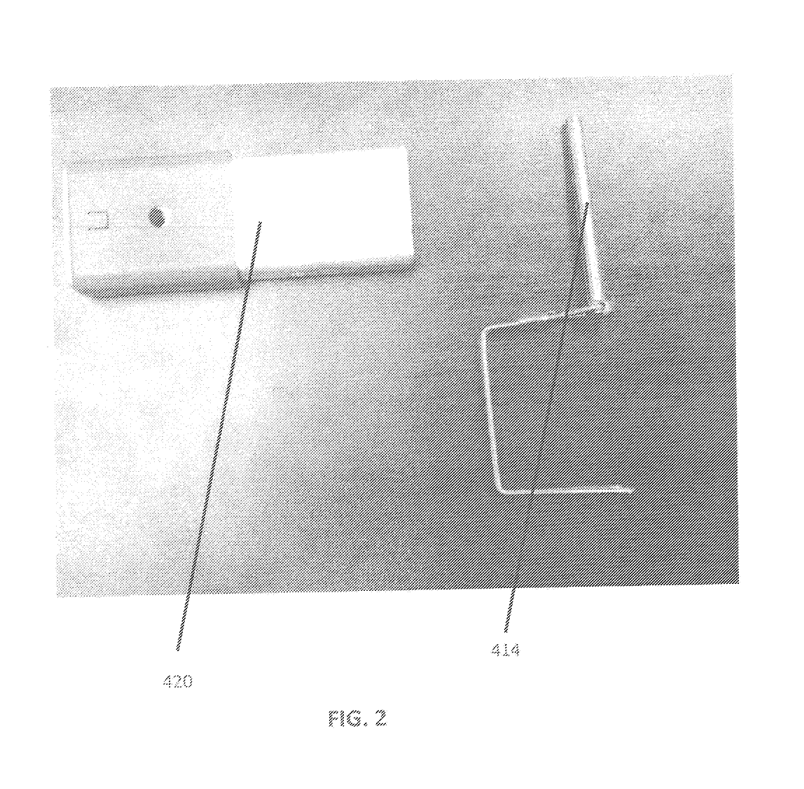

Connector 400 is configured to facilitate releasable engagement of support member 100 to a mounting member, e.g., mounting member 600 that, in turn, is configured to engage a vertical support structure, e.g., a tree “T”. Connector 400 may be configured as a bracket or other suitable connector and includes a retainer 410 configured to releasably engage an engagement member 420. Retainer 410 may include opening 412 for receipt of the engagement member 420 and a locking pin 414 for engaging the engagement member 420 therein. Retainer 410 may further be configured to receive various different engagement members, e.g., engagement member 420 (FIG. 2) and engagement member 420′ (FIG. 6) so as to enable releasable engagement of support member 100 with various different mounting members, e.g., mounting member 600 and mounting member 600′ (FIGS. 5A-6). As can be appreciated, each engagement member corresponds to one or more different mounting members. Regardless of the particular engagement member or mounting member, locking pin 414 is used to engage the engagement member 420 with retainer 410.

Engagement member 420 serves as a male connection feature for releasable receipt within the female connection feature of mounting member 600. Mounting member 600 is configured to engage a tree “T” via teeth 610 and strap 620. More specifically, mounting member 600 is placed against a tree “T” with teeth 610 oriented towards the tree “T.” Thereafter, strap 620 is wrapped around the tree “T” and tightened so as to urge teeth 610 into fixed engagement with the tree “T”. With mounting member 600 in place, engagement member 420 can be inserted into engagement aperture 630 of mounting member 600 to thereby engage support member 100 with the tree “T”. With U-shaped frame 200 of support member 100 engaged with a ladder, e.g., of a tree stand “S”, and connector 400 engaged with mounting member 600, the ladder is secured to the tree “T” in spaced-apart relation relative thereto (see FIG. 4).

Turning to FIGS. 5A-6, another mounting member 600′ configured and dimensioned for use with support member 100 is shown. Mounting member 600′ includes a base 610′ and a threaded shank 620′. Base 610′ serves as a female connection feature for receiving a corresponding engagement member 420′ engaged with connector 400 of support member 100 to secure support member 100 to mounting member 600′. A more detailed discussion of mounting member 600′ can be found in U.S. patent application Ser. No. 14/198,818, filed on Mar. 6, 2014 and entitled “Portable Tree Stand System”, the entire contents of which is incorporated herein by reference.

Referring generally to FIGS. 1-6, the above-detailed configuration of support member 100 and mounting members 600, 600′ provide a safe, secure system for securing a ladder to a structure. Although detailed herein with respect to a ladder of a tree stand “S” secured to a tree “T”, support member 100 and mounting members 600, 600′ can be used for safely securing a ladder to various other structures for various other purposes, for example, to a deck, house, or other building for viewing and/or repairing roofs, to a telephone pole for performing work on power lines, etc.

The above-detailed configuration of support member 100 and mounting members 600, 600′ also enable a user to engage multiple mounting members 600, 600′ to multiple trees “T” or other structures such that support member 100 and the ladder may be transported between and releasably engaged with a plurality of trees “T” or other structures without having to remove the mounting members 600, 600′. This configuration minimizes the visibility of the locations of mounting members 600, 600′, while still enabling fast, easy, and secure installation of a ladder when needed at that particular location.

While several aspects of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed is:

1. A support member for a ladder, the support member comprising:
a U-shaped frame including first and second arms interconnected by a crossbar, each of the first and second arms defining a free end, the free ends of the first and second arms configured and dimensioned to releasably engage opposing sides of a ladder;
a shaft assembly extending from the crossbar of the U-shaped frame in an opposite direction as compared to the first and second arms; and
a connector disposed at a free end of the shaft assembly, the connector configured and dimensioned to releasably engage a mounting member secured to a structure to thereby engage the free end of the shaft assembly to the structure.

2. The support member according to claim 1, wherein the shaft assembly includes an inner shaft and an outer shaft telescopically slidably relative to one another, one of the inner shaft and the outer shaft engaged to the crossbar, the other of the inner shaft and the outer shaft having the connector disposed thereon.

3. The support member according to claim 2, further comprising at least one engagement pin, the at least one engagement pin configured to releasably engage the inner and outer shafts to fix the inner and outer shafts relative to one another.

4. The support member according to claim 1, wherein the connector includes a retainer and a first engagement member releasably engagable with the retainer, the first engagement member configured to releasably engage a first mounting member secured to a structure to thereby engage the free end of the shaft assembly to the structure.

5. The support member according to claim 4, wherein the connector further includes a second engagement member releasably engagable with the retainer, the second engagement member configured to releasably engage a second mounting member different from the first mounting member and secured to a structure to thereby engage the free end of the shaft assembly to the structure.

6. The support member according to claim 4, further comprising a locking pin configured to releasably lock the first engagement member with the retainer.

7. A support system for a ladder, the support system comprising:
a support member, including:
a U-shaped frame including first and second arms interconnected by a crossbar, each of the first and second arms defining a free end, the free ends of the first and second arms configured and dimensioned to releasably engage opposing sides of a ladder;
a shaft assembly extending from the crossbar of the U-shaped frame in an opposite direction as compared to the first and second arms; and
a connector disposed at a free end of the shaft assembly; and
a first mounting member configured to be secured to a structure, wherein the connector is configured and dimensioned to releasably engage the first mounting member to thereby engage the free end of the shaft assembly to the structure.

8. The support assembly according to claim 7, wherein the shaft assembly includes an inner shaft and an outer shaft telescopically slidably relative to one another, one of the inner shaft and the outer shaft engaged to the crossbar, the other of the inner shaft and the outer shaft having the connector disposed thereon.

9. The support system according to claim 8, further comprising at least one engagement pin, the at least one engagement pin configured to releasably engage the inner and outer shafts to fix the inner and outer shafts relative to one another.

10. The support system according to claim 7, wherein the connector includes a retainer and a first engagement member releasably engagable with the retainer, the first engagement member configured and dimensioned to releasably engage the first mounting member.

11. The support system according to claim 10, wherein the first engagement member includes a male engagement feature and wherein the first mounting member includes a female engagement feature configured to accept the male engagement feature.

12. The support system according to claim 7, further comprising:
a second mounting member configured to be secured to a structure, wherein the connector is configured and dimensioned to releasably engage the second mounting member to thereby engage the free end of the shaft assembly to the structure.

13. The support system according to claim 12, wherein the connector includes a retainer, a first engagement member releasably engagable with the retainer and configured to engage the first mounting member, and a second engagement member releasably engagable with the retainer and configured and dimensioned to releasably engage the second mounting member.

14. The support system according to claim 13, further comprising a locking pin configured to releasably lock the first or second engagement member with the retainer.
